(19) United States
(12) Patent Application Publication
(10) Pub. No.: US 2026/0058728 A1
(43) Pub. Date: Feb. 26, 2026

(54) HIGH INTENSITY LUMINAIRE WITH LIGHT-BASED COMMUNICATION AND ILLUMINATION SYSTEM USING THE SAME

(71) Applicant: ABL IP Holding, LLC, Atlanta, GA (US)

(72) Inventors: Christopher D. Nolan, Camillus, NY (US); Joseph R. Casper, Baldwinsville, NY (US)

(21) Appl. No.: 19/307,768

(22) Filed: Aug. 22, 2025

Related U.S. Application Data
(60) Provisional application No. 63/686,689, filed on Aug. 23, 2024.

(51) Int. Cl. H04B 10/116; H04B 10/50; H04B 10/60

(52) U.S. Cl. CPC H04B 10/116; H04B 10/503; H04B 10/60

(57) ABSTRACT

A visible light communication system for use in a stadium may include a control system, a stadium light configured to generate a visible light emission, the visible light emission is configured to illuminate at least a portion of a field within the stadium, the stadium light is communicatively coupled to the control system, the control system is configured to modulate the stadium light such that the visible light emission includes an encoded light signal, a light receiver configured to generate a receiver output in response to the visible light emission being incident thereon, the receiver output including a representation of the encoded light signal, and a user interface communicatively coupled to the light receiver and configured to receive the receiver output.

### CROSS-REFERENCE TO RELATED APPLICATIONS

The present application claims the benefit of U.S. Provisional Application Ser. No. 63/686,689, entitled Li-Fi Communication through a High-Intensity Light, filed Aug. 23, 2024, which is fully incorporated herein by reference.

### TECHNICAL FIELD

The present disclosure is generally related to high intensity luminaires and more specifically related to high intensity luminaires configured to communicate via light-based communication.

### BACKGROUND INFORMATION

Stadium environments (e.g., for sporting events) are configured to simultaneously house large numbers of spectators. The spectators may be provided with access to one or more local area networks, wherein the local area networks may further connect to a remote network (e.g., the internet). When connected to the network, the spectators may utilize network resources, potentially resulting in network congestion and slowdown. The local area networks may utilize radio frequency communication protocols (e.g., Bluetooth, WiFi, and/or the like). While radio frequency networks may offer installation flexibility, radio frequency based networks may exhibit security concerns as a result of being accessible outside of the stadium (e.g., radio frequencies may penetrate the walls of the stadium). Hardwired networks may exhibit increased security but may suffer from a decrease in installation flexibility, when compared to wireless networks such as radio frequency networks.

In some instances, light can be utilized to establish a wireless network (e.g., a light-fidelity, Li-Fi, network). For example, a light source can be modulated to generate a light-based communication signal that is received at a receiver. However, the light-based communication signals may have a limited range and/or be relatively inflexible. For example, the range may be detrimentally impacted by an intensity of surrounding light (e.g., from the stadium lighting, which may overwhelm the light-based communication signal, resulting in the light-based communication signal not being detected at the receiver). This may be countered by increasing an intensity of the light-based communication signal. However, increasing the intensity may involve focusing of the light-based communication signal, potentially reducing an area within which the light-based communication signal can be received. Reducing the area within which the light-based communication signal can be received may reduce the flexibility of the light-based wireless network (e.g., by limiting a number of receivers capable of receiving the light-based communication signal).

### BRIEF DESCRIPTION OF THE DRAWINGS

These and other features and advantages will be better understood by reading the following detailed description, taken together with the drawings, wherein:

FIG. 1 shows a schematic example of a light-based communication system, consistent with embodiments of the present disclosure.

FIG. 2 shows a schematic example of a light-based stadium communication system, consistent with embodiments of the present disclosure.

FIG. 3 shows a schematic example of a stadium light, consistent with embodiments of the present disclosure.

FIG. 4 shows another schematic example of a light-based stadium communication system, consistent with embodiments of the present disclosure.

FIG. 5 shows another schematic example of a light-based stadium communication system, consistent with embodiments of the present disclosure.

FIG. 6 shows another schematic example of a light-based stadium communication system, consistent with embodiments of the present disclosure.

### DETAILED DESCRIPTION

The present disclosure is generally related to a light-based communication system. The light-based communication system includes a general illumination light source configured to generate a visible light emission, a control system configured to control the general illumination light source, and a light receiver configured to generate a receiver output in response to visible light being incident on the light receiver. The control system can be configured to modulate the general illumination light source such that the visible light emission (e.g., in the form of white light) includes an encoded light signal corresponding to data. A rate at which the general illumination light source is modulated may be sufficiently high to be imperceptible to people. As such, the general illumination light source may provide illumination for a space while simultaneously transmitting data via encoded light signals using the same light. When the light receiver is within the space being illuminated by the general illumination light source, the light receiver receives the visible light emission and generates a receiver output that is representative of the encoded light signal. The receiver output may then be provided to a controller (e.g., of a remote device) to act on the data being transmitted. As the light being used to provide general illumination is also being used to generate encoded signals, interference with the encoded light signal that caused by general illumination light sources may be mitigated (e.g., prevented).

In one specific example, the light-based communication system may be deployed in a sports stadium environment. In this example, the stadium lighting may be used to generate the encoded light signal. The encoded light signal may be received by a light receiver that is communicatively coupled to or included within one or more devices (communicators). Use of the stadium lighting to transmit data may reduce congestion on other existing networks within the sports stadium (e.g., radiofrequency networks, such as WiFi, Bluetooth, or cellular networks). Further, when the spectators have devices capable of communicating with the light based communication system, the devices may be capable of accessing, through the use of the light based communication system, remote networks (e.g., the internet), be caused to carry out synchronized behaviors (e.g., illuminate according to specific colors to form shape in the stands, such as a flag), be provided with broadcast notifications (e.g., comments from sporting announcers, advertisements, etc.), and/or the like.

In other examples, the light-based communication system may be deployed at airports, schools, warehouses, concert venues, parking lots/garages, hospitals, emergency response camps, college campuses, railyards, and/or any other suitable location. When the light-based communication system is deployed in areas having restricted sight lines (e.g., at least partially enclosed by walls), external parties may be prevented from communicating with the light-based communication system. In other words, unlike radiofrequency communication systems, the generated light is not capable of passing through walls, which limits reception to line of sight-potentially improving the security of the light-based communication system.

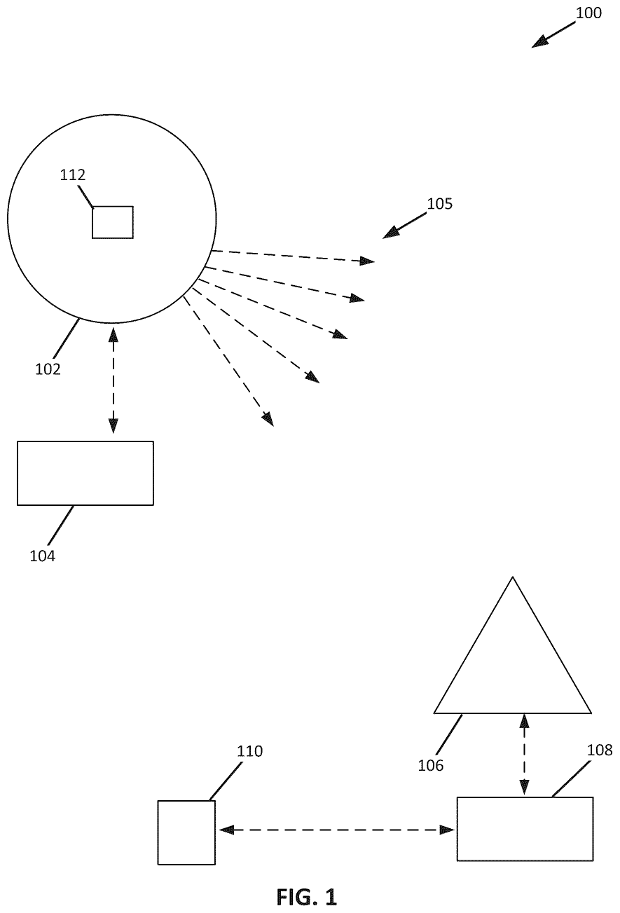

FIG. 1 shows a schematic example of a light-based communication system 100 for use in a large format setting. A large format setting may, for example, include sporting stadiums, outdoor sporting fields, indoor sporting fields, airports, warehouses, concert venues, parking lots/garages, fair grounds, emergency response camps, college campuses, railyards, and/or the like. The light-based communication system 100 may generally be described as a light-fidelity (Li-Fi) communication system. The light-based communication system 100 includes a general illumination light source 102, a control system 104, and a light receiver 106. The general illumination light source 102 is configured to generate a light emission within the visible light spectrum for humans, which may generally be referred to as a visible light emission 105. The control system 104 can be configured to modulate the general illumination light source 102 to generate an encoded light signal using the visible light emission 105. The modulation of the general illumination light source 102 can be of sufficient rate that the modulation is imperceptible to human observers. For example, the general illumination light source 102 may be modulated at frequencies of up to 67 megahertz (MHz) or greater. In some instances, the general illumination light source 102 may be modulated using Pulse Width Modulation (PWM), Quadrature Amplitude Modulation (QAM), Orthogonal Frequency Division Multiplexing (QFDM), and/or any other form of modulation.

The light receiver 106 is configured to detect the visible light emission 105 and generate a receiver output that is representative of the encoded light signal within the visible light emission 105. In other words, the light receiver 106 is configured to generate a receiver output in response to the visible light emission 105 being incident thereon, wherein the receiver output includes a representation of the encoded light signal. In this way, a general illumination light source 102 can be configured to illuminate a space (e.g., a sporting field) with visible light while simultaneously generating an encoded light signal with the same visible light. The light receiver 106 may be, for example, a photodiode (e.g., capable of detecting about 10 microwatts of radiant power or less), an image sensor (e.g., a camera, such as a camera included with a smartphone or tablet computer), and/or any other sensor configured to sense light.

The light receiver 106 can be communicatively coupled to one or more communicators 108. The one or more communicators 108 may be, for example, a handheld device (e.g., a smartphone, a radio, and/or any other handheld device), a tablet computer, a desktop computer, a laptop computer, a wearable device (e.g., a smart watch), and/or the like. The one or more communicators 108 may be configured to receive an output from the light receiver 106 that is representative of the encoded light signal and to carry out one or more behaviors based, at least in part, on the received output. The one or more behaviors may include, for example, presenting (e.g., within a graphic user interface) a message to a user of the one or more communicators 108 (e.g., in the form of voice, text, and/or video). By way of further example, the one or more behaviors may include relaying the received output (in the same or different format) to a remote device 110. The remote device 110 may be communicatively coupled to the one or more communicators 108 via a radiofrequency communication system, a light based communication system, and/or a wired communication system. The remote device 110 may be, for example, a handheld device (e.g., a smartphone, a radio, and/or any other handheld device), a tablet computer, a desktop computer, a laptop computer, a wearable device (e.g., a smart watch), and/or any other remote device capable of communicatively coupling to the one or more communicators 108.

While the encoded light signal is discussed herein as being formed from the visible light emission 105, other configurations are possible. In some instances, one or more encoded light signals (or a portion of an encoded light signal) may be generated using non-visible light (e.g., infrared light). In some instances, the general illumination light source 102 may additionally, or alternatively, include a dedicated laser communication diode 112 configured to be optically coupled to a corresponding light receiver 106. The dedicated laser communication diode 112 may be caused to generate the encoded light signal. The dedicated laser communication diode 112 may use visible or non-visible light. The dedicated laser communication diode 112 may act as back-up to communication with the general illumination light source 102 and may be included with (or separate from) the general illumination light source 102.

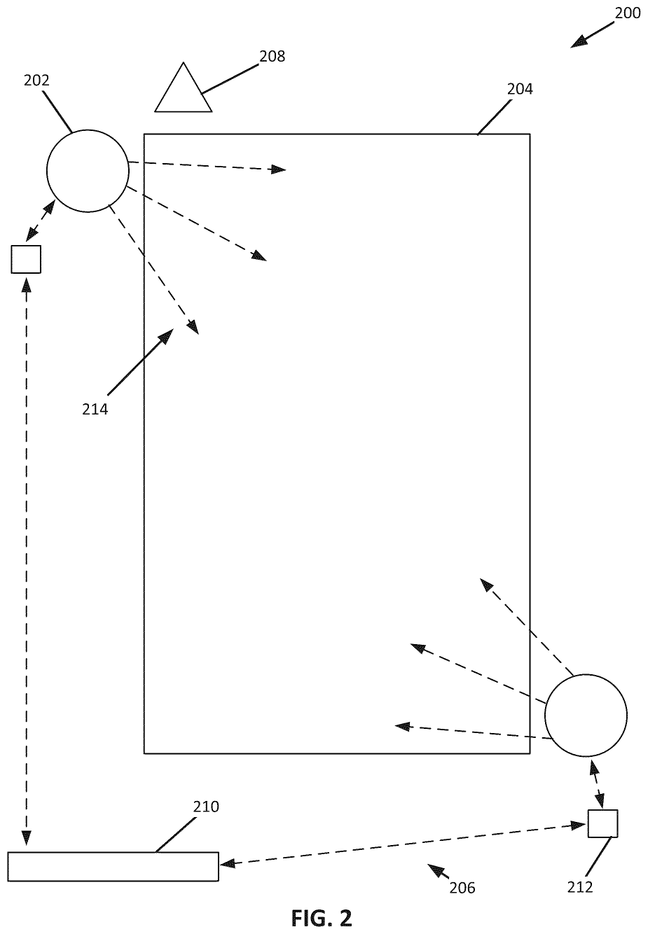

FIG. 2 shows a stadium communication system 200, which is an example of the light-based communication system 100 of FIG. 1. As shown, the stadium communication system 200 includes a plurality of stadium lights 202 (which are an example of the general illumination light source 102 of FIG. 1) configured to direct visible light onto a sporting field 204, at least one control system 206 (which is an example of the control system 104 of FIG. 1), and a light receiver 208 (which is an example of the light receiver 106 of FIG. 1).

The at least one control system 206 is communicatively coupled to each of the stadium lights 202. The at least one control system 206 may include a master controller 210 and a plurality of core controllers 212. Each of the plurality of stadium lights 202 is associated with and communicatively coupled to at least one core controller 212 and each of the core controllers 212 are communicatively coupled to the master controller 210. The master controller 210 may generally be described as being configured to coordinate the operation of each of the core controllers 212 and the core controllers 212 may be generally described as being configured to control the operation of at least a portion of a corresponding stadium light 202. The master controller 210 can be communicatively coupled to each of the core controllers 212 wirelessly (e.g., using light, radiofrequencies, and/or any other form of wireless communication) or via one or more communication wires.

In one example, at least one of the stadium lights 202 may include the light receiver 208. In some instances, each stadium light 202 may include a corresponding light receiver 208 (in other words, the stadium communication system 200 includes at least two light receivers 208). In this example, the light receiver 208 may be communicatively coupled to the core controller 212 corresponding to a respective stadium light 202. In this way, each stadium light 202 can be configured to function as an emitter and a detector. Specifically, each of the stadium lights 202 can be caused to generate a visible light emission 214 having an encoded light signal associated therewith and one or more of (e.g., each of) the light receivers 208 can detect the visible light emission 214 to generate a receiver output that is representative of the encoded light signal. The receiver output can be received by a corresponding core controller 212, which may be configured to act on the receiver output and/or relay the receiver output to the master controller 210.

In another example, at least one light receiver 208 may be separate from the stadium lights 202. In this example, the at least one light receiver 208 may be disposed at an observation location within a stadium (e.g., a coach's box, an owner's box, individual seats within the stadium, and/or the like). Such a configuration may allow the visible light emission 214 generated by each of the stadium lights 202 to broadcast (e.g., unidirectionally) an encoded light signal to one or more locations within the stadium. In this example, the at least one light receiver 208 may be fixed or movable relative to the stadium lights 202.

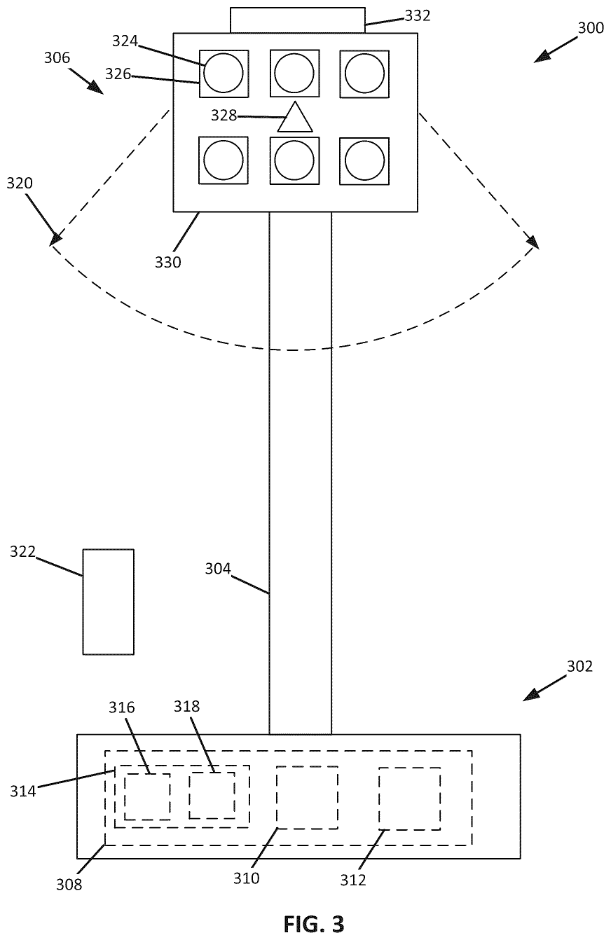

FIG. 3 shows a schematic example of a stadium light 300, which is an example of the stadium light 202 of FIG. 2. As shown, the stadium light 300 includes a light base 302 configured to be coupled to the ground, a lighting pole 304 extending from the light base 302, and a luminaire 306 coupled to the light pole 304 and spaced apart from the light base 302 (e.g., by about 45 m).

The light base 302 includes at least one core controller 308 (which is an example of the core controller 212 of FIG. 2). The core controller 308 may include one or more light drivers 310, a core communication interface 312, and a core control system 314 (e.g., including one or more processors 316 and one or more memories 318, wherein the processors 316 are configured to execute one or more instructions stored on the one or more memories 318). The one or more light drivers 310 are configured to provide power to the luminaire 306 such that the luminaire 306 generates a visible light emission 320. The core control system 314 is configured to cause the one or more light drivers 310 to modulate the luminaire 306 to generate an encoded light signal within the visible light emission 320.

The core communication interface 312 is communicatively coupled to the core control system 314 and to a user interface 322 (e.g., directly and/or indirectly such as via the master controller 210 of FIG. 2). The user interface 322 may be coupled to the stadium light 300 (e.g., the light base 302) and/or may be remote from the stadium light 300 (e.g., implemented in a remote communicator, such as a smartphone or tablet computer). The user interface 322 can be configured to receive one or more instructions from a user that are communicated to the core control system 314 via the core communication interface 312. For example, the received instructions may include data that is configured to be transmitted via the encoded light signal. In this example, the core control system 314, upon receiving the instructions, may cause the one or more light drivers 310 to modulate the luminaire 306 such that the visible light emission 320 includes an encoded light signal that includes the data. The data may include communication data (e.g., text data, voice data, and/or video data), computer data (e.g., computer executable instructions), and/or any other form of data.

The luminaire 306 includes a plurality of laser diodes 324, at least one optical component 326 (e.g., a lens, a diffuser, and/or any other optical component) optically coupled to at least one of the plurality of laser diodes 324, and at least one light receiver 328 (which is an example of the light receiver 208 of FIG. 2). Each of the plurality of laser diodes 324, the optical component 326, and the light receiver 328 may be coupled to (e.g., enclosed within) a luminaire housing 330. The luminaire housing 330 may be configured to be weather resistant and include (e.g., form) one or more heat sinks 332 configured to dissipate heat from the laser diodes 324.

The core controller 308 is communicatively coupled to each of the laser diodes 324 and the at least one light receiver 328. The core controller 308 is configured to modulate the laser diodes 324 to generate the visible light emission 320 (which includes the encoded light signal). The at least one light receiver 328 is configured to receive a visible light emission (e.g., from another stadium light 300) having an encoded light signal and generate a receiver output that includes a representation of the encoded light signal. The receiver output is provided to the core controller 308 such that the data encoded within the encoded light signal can be provided to the user interface 322. Each laser diode 324 may be individually controlled (e.g., each generating a respective encoded light signal) or collectively controlled (e.g., each generating a common encoded light signal). In some instances, one or more laser diodes 324 may be configured for general illumination and one or more laser diodes 324 may be modulated to generate the encoded light signal.

In one specific example, the one or more light drivers 310 may provide an operating power in a range of 6.15 watts (w) to 21.25 w to each laser diode 324. The power provided to each laser diode 324 may be dynamically adjusted to generate the encoded light signal. In this example, the power provided to each laser diode may be dynamically modulated between 6.15 w and 21.25 w to generate the encoded light signal while still being sufficient to provide general illumination. The operating power of the laser diode 324 may be based, at least in part, on a separation distance extending between the laser diode 324 and light receivers 328 which are remote from the laser diodes 324. For example, the remote light receivers 328 may be spaced apart from the laser diodes 324 by at least 25 meters (m), at least 50 m, at least 75 m, at least 100 m, at least 125 m, at least 150 m, at least 200 m, at least 300 m, or at least 400 m.

The laser diodes 324 may collectively provide about 60,000 lumens of light output. The light output may be in a range of 12 million candela to 60 million candela. Such a configuration may allow the transmission of both light and data (e.g., via the encoded light signal) over an outdoor field (e.g., between 100 m and 150 m, between 100 m and 200 m, etc.). Increasing the candela output, may improve a reception range of the encoded light signal.

In one example, each of the plurality of laser diodes 324 is optically coupled to a corresponding optical component 326. Each optical component 326 can be a lens configured to disperse light passing therethrough. In other words, a beam width of the generated laser light may be increased/dispersed as a result of passing through a corresponding optical component 326. In this way, the laser diodes 324 can be used to create the visible light emission 320, wherein the visible light emission 320 provides general illumination of a space (e.g., the sporting field 204 of FIG. 2).

An example of a lens configured to disperse light may include a lens configured to collimate an output of the laser diodes 324 in to a 1° to 2° beam (which is narrower than a typical LED beam such as a NEMA 2 to a NEMA 4 beam). In one example, the lens may be formed of optical-grade silicon (which may provide enhanced thermal stability and/or optical clarity). In some instances, the optical-grade silicon lens may include integrated reflectors and/or co-molded opaque silicon elements, which may improve beam shaping and/or reduce glare. In some instances, a glass lens may be used.

While the luminaire 306 is described as utilizing laser diodes, other illumination sources may be used. For example, the luminaire 306 may use light emitting diodes (LEDs), high intensity discharge (HID) lamps, and/or any other illumination source. Further, while the stadium light 300 is shown and described in the context of having a single luminaire 306, other configurations are possible. For example, the stadium light 300 may include a plurality of luminaires 306 coupled to the lighting pole 304, wherein each luminaire 306 is associated with a respective core controller 308.

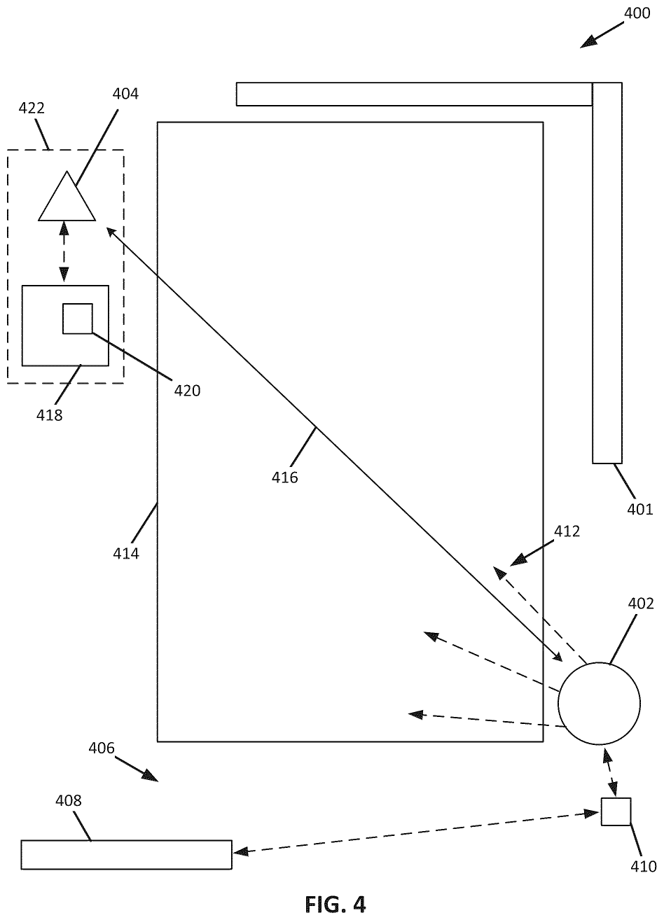

FIG. 4 shows a unidirectional stadium communication system 400, which is an example of the stadium communication system 200 of FIG. 2. As shown, the unidirectional stadium communication system 400 includes a stadium light 402, which is an example of the stadium light 202 of FIG. 2, a light receiver 404, which is an example of the light receiver 208 of FIG. 2, and a control system 406, which is an example of the control system 206 of FIG. 2. The control system 406 includes a master controller 408 and a core controller 410. The master controller 408 is communicatively coupled to the core controller 410. The core controller 410 is configured to cause the stadium light 402 to generate a visible light emission 412 having an encoded light signal. The encoded light signal corresponds to data to be communicated (e.g., communication data or computer data). The visible light emission 412 is further configured to provide general illumination for at least a portion of a sporting field 414.

The light receiver 404 is spaced apart from the stadium light 402 by a light-receiver separation distance 416 and configured to be communicatively coupled to a user interface 418. The light-receiver separation distance 416 may be, for example, in a range of 40 m to 350 m. The light receiver 404 is configured to receive the visible light emission 412 and generate a receiver output, wherein the receiver output includes a representation of the encoded light signal. The user interface 418 may be configured to receive the receiver output and to carry out a behavior associated with the receiver output. For example, the user interface 418 may have an interface controller 420 configured to detect the data associated with the encoded light signal within the receiver output and carry out one or more behaviors based, at least in part, on the detected data. In this example, when the detected data corresponds to a communication, the user interface 418 may generate an audio, visual, and/or text representation corresponding to the communication. Additionally, or alternatively, when the detected data corresponds to a computer operation, the user interface 418 may be caused to carry out the computer operation (e.g., providing information to remote device, adjusting one or more internal settings, and/or the like).

In some instances, the user interface 418 and/or the light receiver 404 may be movable relative to the stadium light 402. In these instances, as the encoded light signal is included with the visible light emission 412 that illuminates at least a portion of the sporting field 414, the encoded light signal is capable of being received by the light receiver 404 whenever the light receiver 404 is exposed to the visible light emission 412. In one example, the light receiver 404 may be included with the user interface 418 to form a mobile unidirectional communicator 422 (which is an example of the communicator 108 of FIG. 1), wherein the mobile unidirectional communicator 422 may be carried by a user. As should be appreciated, in systems including numerous mobile unidirectional communicators 422 (e.g., carried by spectators, coaches, and/or players) a common message may be broadcast (e.g., by a stadium owner/operator, a team owner/operator, an off-field coach or advisor, and/or the like) to each of the mobile unidirectional communicators 422 using the encoded light signal that is included with the visible light emission 412.

Additionally, or alternatively, at least one light receiver 404 may be fixed relative to the stadium light 402. For example, at least one light receiver 404 may be coupled to a portion of a stadium 401 (e.g., adjacent a coach's box, an owner's box, etc.) and communicatively coupled (wired or wirelessly) to the user interface 418.

In some instances, a plurality of the stadium lights 402 may be provided, wherein the master controller 408 is communicatively coupled to each of the core controllers 410 that correspond to respective stadium lights 402. The master controller 408 is configured to coordinate with the core controllers 410 such that each stadium light 402 is configured to generate a corresponding visible light emission 412, wherein at least one visible light emission 412 includes an encoded light signal that is different from an encoded light signal of at least one other visible light emission 412. For example, the mobile unidirectional communicators 422 carried by players within a first portion of the sporting field 414 may receive an encoded light signal that is different from that of a second portion of the sporting field 414. When the encoded light signal corresponds to communication data, such a configuration may allow a coach to direct instructions to players occupying specific portions of the sporting field 414.

When the encoded light signal corresponds to computer data, the mobile unidirectional communicators 422 may be configured to determine a relative to position of the mobile unidirectional communicators 422 (and the associated player) within the sporting field 414. For example, the mobile unidirectional communicators 422 may be configured to receive a visible light emission 412 from at least two different stadium lights 402 simultaneously, wherein each visible light emission includes an at least partially unique encoded light signal (e.g., an encoded light signal that includes a stadium light identifier that is unique to a specific stadium light 402) and, based, at least in part, on a determined angle of incidence of each visible light emission 412 on the mobile unidirectional communicator 422, a location of the mobile unidirectional communicators 422 within the sporting field can be determined. By way of further example, each stadium light 402 can be configured such that an at least partially unique encoded light signal is generated by each stadium light 402 (e.g., an encoded light signal that includes a stadium light identifier that is unique to a specific stadium light 402). Based, at least in part, on the at least partially unique encoded light signal, the mobile unidirectional communicator 422 may be configured to determine a region of the sporting field 414 within which the mobile unidirectional communicator 422 is located. In this example, the at least partially unique encoded light signal having the highest detected intensity may be determined to be the region within which the mobile unidirectional communicator 422 is located. Additionally, or alternatively, the mobile unidirectional communicator 422 may be configured to detect its location within the sporting field 414 based, at least in part, on which at least partially encoded light signal (or signals) are being detected. In other words, the mobile unidirectional communicator 422 may use the presence (or absence) of overlapping visible light emissions 412 to determine its locations within the sporting field 414.

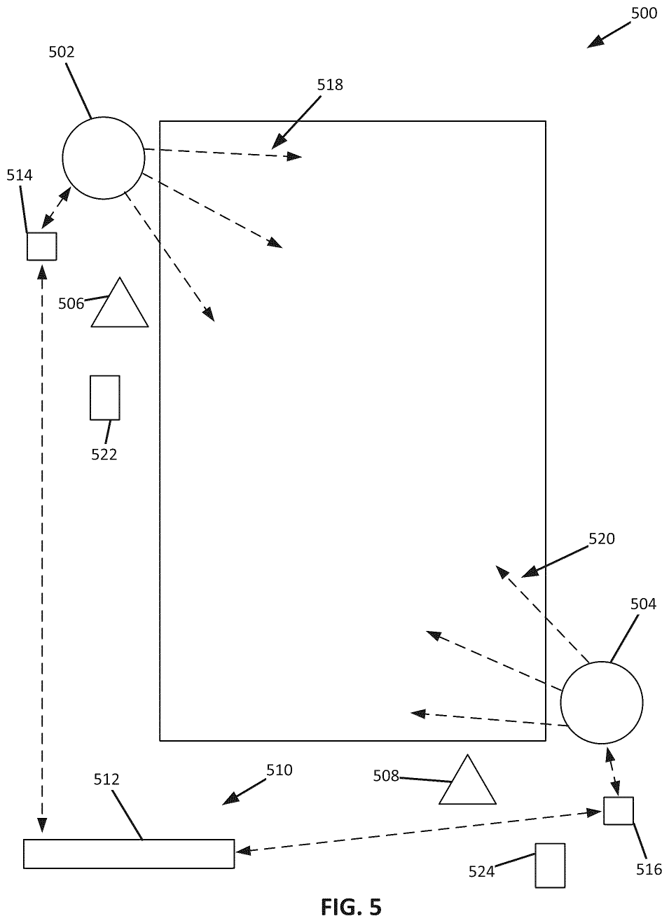

FIG. 5 shows a bidirectional stadium communication system 500, which is an example of the stadium communication system 200 of FIG. 2. As shown, the bidirectional stadium communication system 500 includes at least a first stadium light 502, a second stadium light 504, a first light receiver 506, a second light receiver 508, and a control system 510. The first and second stadium lights 502 and 504 are examples of the stadium light 202 of FIG. 2, the first and second light receivers 506 and 508 are examples of the light receiver 208 of FIG. 2, and the control system 510 is an example of the control system 206 of FIG. 2.

The control system 510 includes a master controller 512, a first core controller 514 associated with the first stadium light 502, and a second core controller 516 associated with the second stadium light 504. The first and second core controllers 514 and 516 are communicatively coupled to the master controller 512.

The first stadium light 502 is configured to generate a first visible light emission 518 that includes a first encoded light signal. For example, the first core controller 514 may be configured to modulate the first stadium light 502 (e.g., by adjusting the power provided to the first stadium light 502) to cause the first visible light emission 518 to include the first encoded light signal. The second stadium light 504 is configured to generate a second visible light emission 520 that includes a second encoded light signal, the second encoded light signal being different from the first encoded light signal. For example, the second core controller 516 may be configured to modulate the second stadium light 504 (e.g., by adjusting the power provided to the second stadium light 504) to cause the second visible light emission 520 to include the second encoded light signal. The first light receiver 506 is configured to detect the second visible light emission 520 and to generate a first receiver output. The second light receiver 508 is configured to detect the first visible light emission 518 and to generate a second receiver output. The first light receiver 506 may be incorporated in the first stadium light 502 and the second light receiver 508 may be incorporated in the second stadium light 504.

The first core controller 514 is configured to cause the first stadium light 502 to generate the first visible light emission 518. The first core controller 514 may be communicatively coupled to a first user interface 522. For example, the first user interface 522 can be configured to receive one or more inputs (e.g., audio, visual, and/or text inputs) from a user, wherein the one or more inputs correspond to data to be transmitted using the first encoded light signal included within the first visible light emission 518. The first user interface 522 may be in the form of a mobile or fixed device.

The second core controller 516 is configured to cause the second stadium light 504 to generate the second visible light emission 520. The second core controller 516 may be communicatively coupled to a second user interface 524. For example, the second user interface 524 can be configured to receive one or more inputs (e.g., audio, visual, and/or text inputs) from a user, wherein the one or more inputs correspond to data to be transmitted using the second encoded light signal included within the second visible light emission 520. The second user interface 524 may be in the form of a mobile or fixed device.

The first light receiver 506 can be communicatively coupled to the first core controller 514 and/or the first user interface 522. The first light receiver 506 is configured to detect the second visible light emission 520 and generate the first receiver output, wherein the first receiver output includes a representation of the second encoded light signal. The first receiver output can be provided to the first core controller 514 and/or the first user interface 522. For example, when the second encoded light signal includes communication data, the communication data (e.g., in the form of text, audio, and/or video) may be presented to the user of the first user interface 522 (e.g., via a display of the first user interface 522). In some instances, the first receiver output is provided to the first controller 514 and the first user interface 522 is communicatively coupled to the first controller 514 such that the first user interface 522 receives the representation of the second encoded light signal from the first core controller 514.

The second light receiver 508 can be communicatively coupled to the second core controller 516 and/or the second user interface 524. The second light receiver 508 is configured to detect the first visible light emission 518 and generate the second receiver output, wherein the second receiver output includes a representation of the first encoded light signal. The second receiver output can be provided to the second core controller 516 and/or the second user interface 524. For example, when the first encoded light signal includes communication data, the communication data (e.g., in the form of text, audio, and/or video) may be presented to the user of the second user interface 524 (e.g., via a display of the second user interface 524). In some instances, the second receiver output is provided to the second controller 516 and the second user interface 524 is communicatively coupled to the second controller 516 such that the second user interface 524 receives the representation of the first encoded light signal from the second core controller 516.

As should be appreciated, in view of the discussion of FIG. 5, bi-directional communication between the first and second user interfaces 522 and 524 may be established using the first and second stadium lights 502 and 504 to generate the first and second encoded light signals. For example, the first and/or second user interfaces 522 and/or 524 may receive one or more user inputs (e.g., data) that is used to generate the first and/or second encoded light signals, respectively. The first and second user interfaces 522 and 524 may be communicatively coupled to the first and second core controllers 514 and 516 using wired or wireless communication (e.g., radiofrequency communication, light based communication, and/or any other form of wireless communication). In some instances, the first and/or second user interfaces 522 and/or 524 may be communicatively coupled (e.g., wired or wirelessly) to the master controller 512 and be configured to communicate with the first and second core controllers 514 and 516 via the master controller 512.

While FIG. 5 is discussed in the context of the first and second user interfaces 522 and 524, it should be appreciated that any number of user interfaces could be used. For example, each encoded light signal can be associated with an interface identifier such that only the intended user interface receives and/or acts on (e.g., displays) data associated with a respective encoded light signal. In this example, multiple substantially simultaneous bi-directional connections (e.g., to external networks such as the internet) may be established without having interference between connections.

Further, while the first and second light receivers 506 and 508 are discussed as being incorporated within the first and second stadium lights 502 and 504, respectively, other configurations are possible. In some instances, the first and second light receivers 506 and 508 may be incorporated within the first and second user interfaces 522 and 524, respectively. In these instances, the first and second user interfaces 522 and 524 may be able to receive data associated with an encoded light signal without being communicatively coupled to the first or second core controller 514 or 516, respectively. When the first and second user interfaces 522 and 524 are not communicatively coupled to the first or second core controller 514 or 516, respectively, the first and second user interfaces 522 and 524 may include a dedicated optical signal generator configured to generate an optical signal capable of being received by a light receiver (e.g., of a corresponding stadium light).

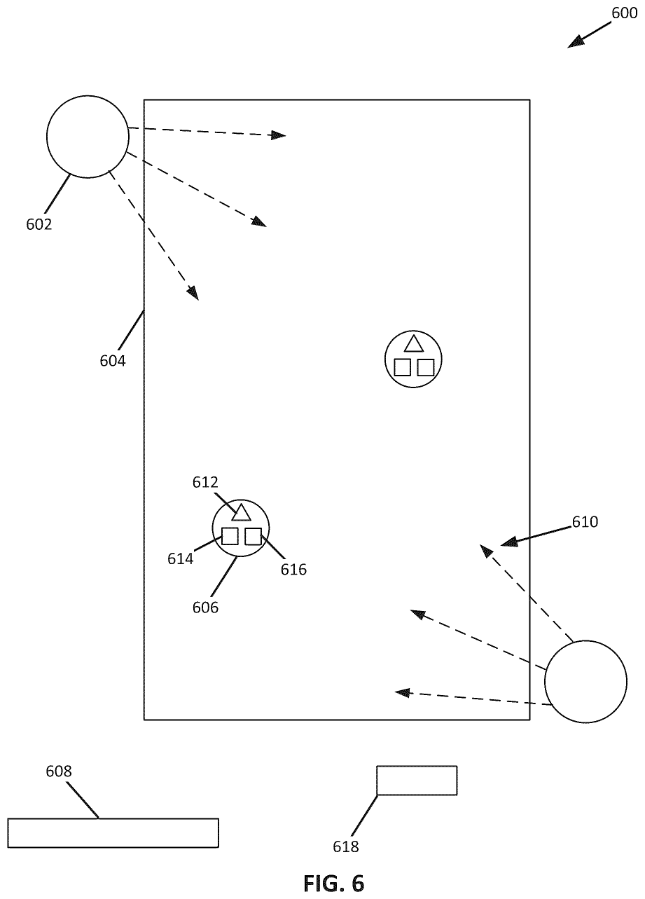

FIG. 6 shows a schematic example of a hybrid bidirectional stadium communication system 600, which is an example of the stadium communication system 200 of FIG. 2. As shown, the hybrid bidirectional stadium communication system 600 includes a plurality of stadium lights 602 (which are examples of the stadium light 202 of FIG. 2) arranged about a periphery of a sporting field 604, a plurality of mobile communicators 606 (e.g., configured to be carried by athletes on the sporting field 604 and which are examples of the communicator 108 of FIG. 1), and a control system 608 (which is an example of the control system 206 of FIG. 2). Each of the stadium lights 602 is configured to generate a visible light emission 610 having an encoded light signal. In some instances, the encoded light signal generated by a respective stadium light 602 may be at least partially unique to that stadium light 602 (e.g., through inclusion of a light identifier). The encoded light signal corresponds to a representation of data.

Each of the plurality of mobile communicators 606 may include a light receiver 612, a communicator communication interface 614, and a communicator controller 616. The light receiver 612 and the communicator communication interface 614 are communicatively coupled to the communicator controller 616. The light receiver 612 is configured to detect the visible light emission 610 and to generate a receiver output that corresponds to the visible light emission 610. As such, the receiver output includes a representation of the encoded light signal. The receiver output is provided to the communicator controller 616 such that the communicator controller 616 can identify the data represented by the encoded light signal. In response to identifying the data, the communicator controller 616 may be caused to carry out one or more behaviors.

The communicator communication interface 614 may be configured to communicatively couple (e.g., wirelessly) to the control system 608 and/or a remote device 618. While the communicator communication interface 614 may be configured to communicate via visible light, other configurations are possible. For example, the communicator communication interface 614 may be configured to communicate using radiofrequency communication (e.g., WiFi or Bluetooth). In this way, the mobile communicators 606 are each configured to receive communications of data via the light receiver 612 and to transmit communications of data via radiofrequency. In other words, the mobile communicators 606 may be configured for hybrid bidirectional communication (e.g., using at least two different forms of communication).

In one specific example, each of the mobile communicators 606 may be configured as a wearable device configured to gather real-time health data of the wearer. In this example, the encoded light signal may correspond to a request for health data (e.g., by medical personnel and/or trainers). In response to the light receiver 612 receiving the visible light emission 610 that includes the encoded light signal, the light receiver 612 may generate a receiver output that is provided to the communicator controller 616. The receiver output includes a representation of the request for health data. The communicator controller 616 is configured to analyze the receiver output and detect the request for health data. In response to the communicator controller 616 detecting the request for health data, the communicator controller 616 may cause the relevant health data to the transmitted to the requestor using the communicator communication interface 614 (e.g., via a radiofrequency communication).

In another specific example, each of the mobile communicators 606 may be configured to detect a relative location of the user on the sporting field 604. In this example, if each stadium light 602 is configured to generate an at least partially unique encoded light signal, the mobile communicator 606 can be configured to detect a relative position of the mobile communicator 606 to at least two stadium lights 602. The mobile communicator 606 can then determine its relative location on the sporting field 604 based, at least in part, on its detected position relative to the at least two stadium lights 602. In response to determining its relative location on the sporting field 604, the mobile communicator 606 can transmit the location using the communicator communication interface 614 to the control system 608 and/or the remote device 618. The location data can be used to track movements of the mobile communicators 606. Tracking movement of the mobile communicators 606 may allow the intensity of the stadium lights 602 to be dynamically adjusted to correspond to locations on the sporting field 604 having the most activity.

An example of a visible light communication system for use in a stadium, consistent with the present disclosure, may include a control system, a stadium light configured to generate a visible light emission, the visible light emission is configured to illuminate at least a portion of a field within the stadium, the stadium light is communicatively coupled to the control system, the control system is configured to modulate the stadium light such that the visible light emission includes an encoded light signal, a light receiver configured to generate a receiver output in response to the visible light emission being incident thereon, the receiver output including a representation of the encoded light signal, and a user interface communicatively coupled to the light receiver and configured to receive the receiver output.

In some instances, the stadium light may include a laser diode configured to generate visible light. In some instances, the laser diode may be optically coupled to a lens configured to disperse light. In some instances, the visible light communication system may further include an additional stadium light, the additional stadium light including the light receiver. In some instances, the visible light communication system may further include a mobile communicator, the mobile communicator including the user interface and the light receiver. In some instances, the mobile communicator may be configured to be worn by a user. In some instances, the control system may include a master controller and a core controller, the core controller being configured to control operation of the stadium light and the master controller being communicatively coupled to the core controller.

Another example of a visible light communication system for use in a stadium, consistent with the present disclosure, may include a first stadium light configured to generate a first visible light emission and including a first light receiver, the first visible light emission is configured to illuminate at least a portion of a field within the stadium, a second stadium light configured to generate a second visible light emission and including a second light receiver, the second visible light emission is configured to illuminate at least a portion of the field within the stadium, a control system, a first user interface, and a second user interface. The control system may include a first core controller communicatively coupled to the first light receiver and configured to modulate the first stadium light to cause the first visible light emission to include a first encoded light signal, a second core controller communicatively coupled to the second light receiver and configured to modulate the second stadium light to cause the second visible light emission to include a second encoded light signal, and a master controller communicatively coupled to each of the first and second core controllers, wherein: the first light receiver is configured to generate a first receiver output in response to the second visible light emission being incident thereon, the first receiver output including a representation of the second encoded light signal and the second light receiver is configured to generate a second receiver output in response to the first visible light emission being incident thereon, the second receiver output including a representation of the first encoded light signal. The first user interface may be communicatively coupled to the first core controller to receive the representation of the second encoded light signal. The second user interface may be communicatively coupled to the second core controller to receive the representation of the first encoded light signal.

In some instances, the first and second visible light emissions are generated using a plurality of laser diodes configured to generate visible light. In some instances, the visible light communication system may further include a first mobile communicator and a second mobile communicator, the first mobile communicator including the first user interface and the first light receiver and the second mobile communicator including the second user interface and the second light receiver. In some instances, the first mobile communicator may be configured to communicatively couple with the first core controller using radiofrequency communication. In some instances, the first mobile communicator may be configured to communicate data to the first core controller using radiofrequency communication, the data being used to generate the first encoded light signal. In some instances, the first and second mobile communicators may be configured to be worn by a user. In some instances, the first and second mobile communicators may be configured to determine a location of each user within the field based, at least in part, on the first and second visible light emissions.

Another example of a visible light communication system for use in a stadium, consistent with the present disclosure, may include a control system, a stadium light configured to generate a visible light emission using a plurality of laser diodes that are configured to generate visible light, the visible light emission is configured to illuminate at least a portion of a field within the stadium, the stadium light is communicatively coupled to the control system, the control system is configured to modulate the plurality of laser diodes such that the visible light emission includes an encoded light signal, a light receiver configured to generate a receiver output in response to the visible light emission being incident thereon, the receiver output including a representation of the encoded light signal, and a user interface communicatively coupled to the light receiver and configured to receive the receiver output.

In some instances, the visible light communication system may further include an additional stadium light, the additional stadium light including the light receiver. In some instances, the visible light communication system may further include a mobile communicator, the mobile communicator including the user interface and the light receiver. In some instances, the mobile communicator may be configured to be worn by a user. In some instances, the mobile communicator may be configured to communicatively couple to the control system using radiofrequency communication. In some instances, the control system may include a master controller and a core controller, the core controller being configured to control operation of the stadium light and the master controller being communicatively coupled to the core controller.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A visible light communication system for use in a stadium comprising:
a control system;
a stadium light configured to generate a visible light emission, the visible light emission is configured to illuminate at least a portion of a field within the stadium, the stadium light is communicatively coupled to the control system, the control system is configured to modulate the stadium light such that the visible light emission includes an encoded light signal;
a light receiver configured to generate a receiver output in response to the visible light emission being incident thereon, the receiver output including a representation of the encoded light signal; and
a user interface communicatively coupled to the light receiver and configured to receive the receiver output.

2. The visible light communication system of claim 1, wherein the stadium light includes a laser diode configured to generate visible light.

3. The visible light communication system of claim 2, wherein the laser diode is optically coupled to a lens configured to disperse light.

4. The visible light communication system of claim 1 further comprising an additional stadium light, the additional stadium light including the light receiver.

5. The visible light communication system of claim 1 further comprising a mobile communicator, the mobile communicator including the user interface and the light receiver.

6. The visible light communication system of claim 5, wherein the mobile communicator is configured to be worn by a user.

7. The visible light communication system of claim 1, wherein the control system includes a master controller and a core controller, the core controller being configured to control operation of the stadium light and the master controller being communicatively coupled to the core controller.

8. A visible light communication system for use in a stadium comprising:
a first stadium light configured to generate a first visible light emission and including a first light receiver, the first visible light emission is configured to illuminate at least a portion of a field within the stadium;
a second stadium light configured to generate a second visible light emission and including a second light receiver, the second visible light emission is configured to illuminate at least a portion of the field within the stadium;
a control system including:
a first core controller communicatively coupled to the first light receiver and configured to modulate the first stadium light to cause the first visible light emission to include a first encoded light signal;
a second core controller communicatively coupled to the second light receiver and configured to modulate the second stadium light to cause the second visible light emission to include a second encoded light signal; and
a master controller communicatively coupled to each of the first and second core controllers, wherein:
the first light receiver is configured to generate a first receiver output in response to the second visible light emission being incident thereon, the first receiver output including a representation of the second encoded light signal; and
the second light receiver is configured to generate a second receiver output in response to the first visible light emission being incident thereon, the second receiver output including a representation of the first encoded light signal;
a first user interface communicatively coupled to the first core controller to receive the representation of the second encoded light signal; and
a second user interface communicatively coupled to the second core controller to receive the representation of the first encoded light signal.

9. The visible light communication system of claim 8, wherein the first and second visible light emissions are generated using a plurality of laser diodes configured to generate visible light.

10. The visible light communication system of claim 8 further comprising a first mobile communicator and a second mobile communicator, the first mobile communicator including the first user interface and the first light receiver and the second mobile communicator including the second user interface and the second light receiver.

11. The visible light communication system of claim 10, wherein the first mobile communicator is configured to communicatively couple with the first core controller using radiofrequency communication.

12. The visible light communication system of claim 11, wherein the first mobile communicator is configured to communicate data to the first core controller using radiofrequency communication, the data being used to generate the first encoded light signal.

13. The visible light communication system of claim 10, wherein the first and second mobile communicators are configured to be worn by a user.

14. The visible light communication system of claim 13, wherein the first and second mobile communicators are configured to determine a location of each user within the field based, at least in part, on the first and second visible light emissions.

15. A visible light communication system for use in a stadium comprising:
a control system;
a stadium light configured to generate a visible light emission using a plurality of laser diodes that are configured to generate visible light, the visible light emission is configured to illuminate at least a portion of a field within the stadium, the stadium light is communicatively coupled to the control system, the control system is configured to modulate the plurality of laser diodes such that the visible light emission includes an encoded light signal;
a light receiver configured to generate a receiver output in response to the visible light emission being incident thereon, the receiver output including a representation of the encoded light signal; and
a user interface communicatively coupled to the light receiver and configured to receive the receiver output.

16. The visible light communication system of claim 15 further comprising an additional stadium light, the additional stadium light including the light receiver.

17. The visible light communication system of claim 15 further comprising a mobile communicator, the mobile communicator including the user interface and the light receiver.

18. The visible light communication system of claim 17, wherein the mobile communicator is configured to be worn by a user.

19. The visible light communication system of claim 17, wherein the mobile communicator is configured to communicatively couple to the control system using radiofrequency communication.

20. The visible light communication system of claim 15, wherein the control system includes a master controller and a core controller, the core controller being configured to control operation of the stadium light and the master controller being communicatively coupled to the core controller.
